(19) United States
(12) Patent Application Publication
(10) Pub. No.: US 2025/0210696 A1
(43) Pub. Date: Jun. 26, 2025

(54) SOLID ELECTROLYTE LAYER, SOLID-STATE BATTERY AND METHOD FOR PRODUCING SOLID-STATE BATTERY

(71) Applicant: TOYOTA JIDOSHA KABUSHIKI KAISHA, Aichi-ken (JP)

(72) Inventor: Ippei GOTO, Okazaki-shi (JP)

(21) Appl. No.: 18/985,025

(22) Filed: Dec. 18, 2024

(30) Foreign Application Priority Data
Dec. 26, 2023 (JP) 2023-219119

(51) Int. Cl. H01M 10/0562; D04H 1/413; D04H 1/435; D04H 1/4382; H01M 4/38; H01M 4/525; H01M 10/0585; H01M 50/414; H01M 50/437; H01M 50/44; H01M 50/443; H01M 50/451; H01M 50/454; H01M 50/491

(52) U.S. Cl. CPC H01M 10/0562; D04H 1/413; D04H 1/435; D04H 1/43838; H01M 4/386; H01M 4/525; H01M 10/0585; H01M 50/414; H01M 50/437; H01M 50/44; H01M 50/443; H01M 50/451; H01M 50/454; H01M 50/491; D10B 2401/10; D10B 2505/00; H01M 2300/008

(57) ABSTRACT

To provide a solid electrolyte layer configured to suppress an increase in resistance, a solid-state battery, and a method for producing the solid-state battery. A solid electrolyte layer for solid-state batteries, wherein the solid electrolyte layer comprises a nonwoven fabric and a solid electrolyte; wherein the solid electrolyte is disposed in an interior of the nonwoven fabric; wherein the solid electrolyte is solid electrolyte particles; and wherein a ratio of an average fiber diameter of the nonwoven fabric to an average particle diameter of the solid electrolyte particles, is 25 or more and 100 or less.

### TECHNICAL FIELD

The disclosure relates to a solid electrolyte layer, a solid-state battery and a method for producing the solid-state battery.

### BACKGROUND

Various studies have been proposed for a solid electrolyte layer including a nonwoven fabric as disclosed in Patent Documents 1 and 2.
Patent Document 1: Japanese Patent Application Laid-Open (JP-A) No. 2016-031789
Patent Document 2: JP-A No. 2020-188026

In a solid electrolyte layer including a nonwoven fabric, an increase in resistance occurs when the basis weight of the nonwoven fabric is too large, and a decrease in tensile strength occurs when the basis weight of the nonwoven fabric is too small.

### SUMMARY

The present disclosure was achieved in light of the above circumstances. An object of the present disclosure is to provide a solid electrolyte layer configured to suppress an increase in resistance, a solid-state battery, and a method for producing the solid-state battery.

The present disclosure includes the following embodiments.
<1> A solid electrolyte layer for solid-state batteries,
   wherein the solid electrolyte layer comprises a nonwoven fabric and a solid electrolyte;
   wherein the solid electrolyte is disposed in an interior of the nonwoven fabric;
   wherein the solid electrolyte is solid electrolyte particles; and
   wherein a ratio of an average fiber diameter of the nonwoven fabric to an average particle diameter of the solid electrolyte particles, is 25 or more and 100 or less.
<2> The solid electrolyte layer according to <1>, wherein the ratio of the average fiber diameter of the nonwoven fabric to the average particle diameter of the solid electrolyte particles, is 25 or more and 50 or less.
<3> The solid electrolyte layer according to <1> or <2>, wherein a porosity of the nonwoven fabric is 73% or more and less than 91%.
<4> The solid electrolyte layer according to any one of <1> to <3>, wherein an average fiber diameter of the nonwoven fabric is 3 μm or more and 10 μm or less.
<5> The solid electrolyte layer according to any one of <1> to <4>, wherein an average particle diameter of the solid electrolyte particles is 0.1 μm or more and less than 0.5 μm.
<6> The solid electrolyte layer according to any one of <1> to <5>, wherein the nonwoven fabric is composed of polyethylene terephthalate.
7. The solid electrolyte layer according to any one of <1> to <6>, wherein the solid electrolyte contains a sulfide solid electrolyte.
<8> A solid-state battery comprising an anode layer, a cathode layer, and the solid electrolyte layer defined by any one of <1> to <7> and disposed between the anode layer and the cathode layer.
<9> The solid-state battery according to <8>, wherein the anode layer contains a Si-based active material as an anode active material.
<10> The solid-state battery according to <8> or <9>,
   wherein the cathode layer contains a cathode active material, and
   wherein the cathode active material contains a Ni element and a Co element.
<11> A method for producing a solid-state battery, comprising:
   obtaining a stack by disposing the solid electrolyte layer defined by any one of <1> to <7> between an anode layer and a cathode layer, and
   pressing the stack.

According to the present disclosure, a solid electrolyte layer configured to suppress an increase in resistance, a solid-state battery, and a method for producing the solid-state battery can be provided.

### BRIEF DESCRIPTION OF THE DRAWING

FIG. 1 is a graph showing a relationship between the resistance of each solid-state battery and the ratio of the average fiber diameter of the nonwoven fabric of each of the solid electrolyte layers produced in Examples 1 to 5 and Comparative Examples 2, 5, 7 and 8 to the average particle diameter of the solid electrolyte particles thereof (the average fiber diameter of the nonwoven fabric/the average particle diameter of the solid electrolyte particles).

### DETAILED DESCRIPTION

Hereinafter, the embodiments of the present disclosure will be described in detail. Matters that are required to implement the present disclosure (such as common solid electrolyte layer and solid-state battery structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In the present disclosure, unless otherwise noted, the average particle diameter of the particles is the value of a median diameter (D50) which is particle diameter at an accumulated value of 50% in a volume-based particle size distribution measured by laser diffraction and scattering particle size distribution measurement.

### 1. Solid Electrolyte Layer

According to the present disclosure, there is provided a solid electrolyte layer for solid-state batteries,
wherein the solid electrolyte layer comprises a nonwoven fabric and a solid electrolyte;
wherein the solid electrolyte is disposed in an interior of the nonwoven fabric;
wherein the solid electrolyte is solid electrolyte particles; and
wherein a ratio of an average fiber diameter of the nonwoven fabric to an average particle diameter of the solid electrolyte particles, is 25 or more and 100 or less.

In the solid electrolyte layer of the present disclosure, the average fiber diameter of the nonwoven fabric included in the solid electrolyte layer is increased while keeping the porosity of the nonwoven fabric high, thereby decreasing the number of the fibers of the nonwoven fabric and increasing the pore diameter. With respect to the average fiber diameter of the nonwoven fabric, the average particle diameter of the solid electrolyte particles is sufficiently decreased. Accordingly, while keeping the tensile strength of the solid electrolyte layer at a desired level, the solid electrolyte (SE) particles in the solid electrolyte layer are likely to be brought into contact with each other; the number of ion conductive paths is increased; and an increase in resistance, which is due to the included nonwoven fabric, can be suppressed, accordingly.

The solid electrolyte layer of the present disclosure comprises the nonwoven fabric, the solid electrolyte and, as needed, a binder, etc. The solid electrolyte layer of the present disclosure is for use in solid-state batteries.

The term “nonwoven fabric” is a sheet formed by attaching or entangling fibers, without weaving them. It also means a planar fiber assembly having a certain level of structural strength which is imparted by a physical and/or chemical method other than weaving, knitting and papermaking (JIS L0222:2022).

The term “pore diameter” means the maximum pore diameter determined by the bubble point method (JIS K3832).

The plan-view shape of the solid electrolyte layer is not particularly limited, and examples thereof include, but are not limited to, a rectangular shape. As the rectangular shape, examples include, but are not limited to, a square shape and a rectangle shape.

The thickness of the solid electrolyte layer depends on the thickness of the nonwoven fabric. The thickness of the solid electrolyte layer may be equal to or more than the thickness of the nonwoven fabric.

From the viewpoint of decreasing the resistance of the solid-state battery, the thickness of the solid electrolyte layer may be 50 μm or less, may be 30 μm or less, may be 20 μm or less, or may be 15 μm or less. On the other hand, the thickness of the solid electrolyte layer may be 1 μm or more, or it may be 10 μm or more.

### [Nonwoven Fabric]

The type of the nonwoven fabric is not particularly limited. As the type of the nonwoven fabric, examples include, but are not limited to, a meltblown nonwoven fabric, a spunbonded nonwoven fabric, a carded nonwoven fabric, a parallel-laid nonwoven fabric, a cross-laid nonwoven fabric, a random-laid nonwoven fabric, a spunlaid nonwoven fabric, a flashspun nonwoven fabric, a chemical bonded nonwoven fabric, a hydroentangled nonwoven fabric, a needle-punched nonwoven fabric, a stitch-bonded nonwoven fabric, a thermal bonded nonwoven fabric, a burst fiber nonwoven fabric, a tow opening nonwoven fabric and a film split nonwoven fabric.

As the material for the nonwoven fabric, examples include, but are not limited to, resin and glass. As the material for the resin, examples include, but are not limited to, polyester resin, polyolefin resin and polyamide resin. As the polyester resin, examples include, but are not limited to, polyethylene terephthalate (PET). As the polyolefin resin, examples include, but are not limited to, polyethylene (PE) and polypropylene (PP). As the polyamide resin, examples include, but are not limited to, nylon and aramid. The nonwoven fabric may be composed of polyethylene terephthalate, since it has high heat resistance and it is less likely to deteriorate at high temperatures.

The porosity of the nonwoven fabric is not particularly limited. From the viewpoint of further decreasing the resistance of the solid-state battery, the porosity of the nonwoven fabric may be 50% or more, may be 60% or more, may be 70% or more, or may be 73% or more. On the other hand, from the point of view that the resistance can be decreased while maintaining the tensile strength of the solid electrolyte layer, the porosity of the nonwoven fabric may be less than 91%, may be 90% or less, or may be 77% or less. The porosity of the nonwoven fabric may be 73% or more and less than 91%.

The porosity means the volume of voids in the interior of the nonwoven fabric with respect to the total volume of the nonwoven fabric.

The porosity of the nonwoven fabric can be calculated as follows: the volume of the voids is calculated from the difference between the actual volume of the nonwoven fabric and the volume calculated from the specific gravity of the material of the nonwoven fabric, and then the percentage of the voids with respect to the actual volume of the nonwoven fabric is calculated, thereby obtaining the porosity of the nonwoven fabric.

The average fiber diameter of the nonwoven fabric is not particularly limited, and it may be 3 μm or more and 10 μm or less. When the average fiber diameter of the nonwoven fabric is too large, the thickness of the solid electrolyte layer increases. When the average fiber diameter of the nonwoven fabric is too small, the nonwoven fabric cannot support the solid electrolyte. Accordingly, when the average fiber diameter of the nonwoven fabric is within the above range, the solid electrolyte can be supported while keeping the thickness of the solid electrolyte layer small.

The average fiber diameter of the nonwoven fabric may be calculated by measuring the diameter of 100 fibers in a desired portion of the nonwoven fabric on an electron micrograph and then calculating the arithmetic mean value thereof.

The fibers of the nonwoven fabric may be long or short fibers. The cross-sectional shape of the fibers is not particularly limited. As the cross-sectional shape, examples include, but are not limited to, a circular shape, an oval shape and an odd shape.

The thickness of the nonwoven fabric is not particularly limited. It may be 10 μm or more, may be 60 μm or less, or may be 30 μm or less. Since the thickness of the nonwoven fabric is from 10 μm to 60 μm, the thickness of the solid electrolyte layer of the solid-state battery can be further decreased. As a result, the resistance of the solid-state battery can be further decreased.

The basis weight of the nonwoven fabric is not particularly limited. For example, from the viewpoint of further decreasing the resistance of the solid-state battery, the basis weight of the nonwoven fabric may be 0.10 g/cm² or more and 1 g/cm² or less.

The pore diameter of the nonwoven fabric is not particularly limited, and it may be from 1 μm to 15 μm.

The nonwoven fabric can be produced by a conventionally-known method such as the meltblown method and the spunbonding method. The average fiber diameter, pore diameter, thickness and porosity of the nonwoven fabric can be controlled by a conventionally-known method.

### [Solid Electrolyte]

The solid electrolyte is disposed in the interior of the nonwoven fabric. As long as the solid electrolyte is disposed in the interior of the nonwoven fabric, the solid electrolyte may or may not cover the nonwoven fabric.

As the solid electrolyte, examples include, but are not limited to, an inorganic solid electrolyte such as a sulfide solid electrolyte, an oxide solid electrolyte, a hydride solid electrolyte, a halide solid electrolyte and a nitride solid electrolyte, and an organic high molecular electrolyte such as a polymer electrolyte. From the viewpoint of suppressing the removal of the solid electrolyte layer from the cathode and anode layers and further decreasing the resistance of the solid-state battery, a relatively soft sulfide solid electrolyte may be used as the solid electrolyte. As the solid electrolyte, one kind of solid electrolyte may be used, or two or more kinds of solid electrolytes may be used in combination. In the case of using two or more kinds of solid electrolytes, they may be mixed together, or they may be formed into layers to obtain a multilayer structure.

The amount of the solid electrolyte in the solid electrolyte layer is not particularly limited. For example, it may be 50 mass % or more and 99 mass % or less.

The percentage total volume of the solid electrolyte with respect to the total volume of the voids in the nonwoven fabric, may be 50 vol. % or more, may be 70 vol. % or more, or may be 90 vol. % or more.

As the sulfide solid electrolyte, examples include, but are not limited to, a solid electrolyte containing a Li element, an A element and a S element. The A element is at least one of P, As, Sb, Si, Ge, Sn, B, Al, Ga or In. The sulfide solid electrolyte may further contain at least one of an O element or a halogen element. As the halogen element (X), examples include, but are not limited to, a F element, a Cl element, a Br element and an I element. The sulfide solid electrolyte may be glass (amorphous), glass ceramics or crystalline. When the sulfide solid electrolyte is crystalline, the sulfide solid electrolyte has a crystalline phase. As the crystalline phase, examples include, but are not limited to, a Thio-LISICON-type crystalline phase, a LGPS-type crystalline phase and an argyrodite-type crystalline phase. As the sulfide solid electrolyte, examples include, but are not limited to, Li₂S—P₂S₅, LiI—Li₂S—P₂S₅, LiI—LiBr—Li₂S—P₂S₅, Li₂S—SiS₂, Li₂S—GeS₂ and Li₂S—P₂S₅—GeS₂. Note that the description “Li₂S—P₂S” means a material consisting of a raw material composition including Li₂S and P₂S₅, and the same applies to other descriptions. The molar ratio of the elements in the sulfide solid electrolyte can be controlled by adjusting the amounts of the elements in the raw material. Also, the molar ratio and composition of the elements in the sulfide solid electrolyte can be measured by ICP emission spectrometry, for example.

For example, the oxide solid electrolyte may be a solid electrolyte containing a Li element, a Z element (Z is at least one of Nb, B, Al, Si, P, Ti, Zr, Mo, W and S) and an O element. For example, the oxide solid electrolyte may be Li₂O—B₂O₃—P₂O₅, Li₂O—SiO₂, Li₂O—B₂O₃, Li_{1.3}Al_{0.3}Ti_{0.7}(PO₄)₃, Li₅La₃Ta₂O₁₂, Li₇La₃Zr₂O₁₂, Li₆BaLa₂Ta₂O₁₂, Li_{3.6}Si_{0.6}P_{0.4}O₄, Li₄SiO₄, Li₃PO₄, Li₃₊ₓPO₄₋ₓNₓ (1≤x≤3) or the like.

For example, the hydride solid electrolyte contains Li and a complex anion containing hydrogen. As the complex anion, examples include, but are not limited to, (BH₄)⁻, (NH₂)⁻, (AlH₄)⁻ and (AlH₆)³⁻.

As the halide based solid electrolyte, examples include, but are not limited to, LiF, LiCl, LiBr, LiI and LiI-Al₂O₃.

As the nitride solid electrolyte, examples include, but are not limited to, Li₃N.

As the binder, examples include, but are not limited to, a rubber-based binder and a fluoride-based binder. As the rubber-based binder, examples include, but are not limited to, butadiene rubber, hydrogenated butadiene rubber, styrene-butadiene rubber (SBR), hydrogenated styrene-butadiene rubber, nitrile-butadiene rubber, hydrogenated nitrile-butadiene rubber and ethylene-propylene rubber. As the fluoride-based binder, examples include, but are not limited to, polyvinylidene fluoride (PVDF), a polyvinylidene fluoride-polyhexafluoropropylene copolymer (PVDF-HFP), polytetrafluoroethylene and fluorine rubber.

When the solid electrolyte layer contains the binder, the amount of the contained binder may be from 0 part by mass to 3 parts by mass, with respect to the total amount of the solid electrolyte layer.

The solid electrolyte is solid electrolyte particles.

The average particle diameter (D50) of the solid electrolyte particles is not particularly limited. From the viewpoint of decreasing the battery resistance, the average particle diameter may be 0.1 μm or more, may be less than 0.5 μm, or may be 0.2 μm or less.

### [Average Fiber Diameter of the Nonwoven Fabric/Average Particle Diameter of the Solid Electrolyte Particles]

In the present disclosure, the ratio of the average fiber diameter of the nonwoven fabric to the average particle diameter of the solid electrolyte particles (the average fiber diameter of the nonwoven fabric/the average particle diameter of the solid electrolyte particles) may be 25 or more and 100 or less, or it may be 25 or more and 50 or less. This is because when the ratio is within the range, the resistance can be decreased while suppressing an increase in the thickness of the solid electrolyte layer which is due to an increase in the average fiber diameter of the nonwoven fabric.

The solid electrolyte layer can be formed by the following method, for example.

First, a solid electrolyte paste containing the solid electrolyte, the binder and the solvent is produced; the nonwoven fabric is disposed on a release film; and the solid electrolyte paste is applied to the nonwoven fabric disposed on the release film, thereby forming the solid electrolyte layer.

As the solvent, examples include, but are not limited to, butyl acetate, butyl butyrate, heptane and N-methyl-2-pyrrolidone.

### 2. Solid-State Battery

The solid-state battery of the present disclosure comprises an anode comprising an anode layer, a cathode comprising a cathode layer, and the solid electrolyte layer of the present disclosure disposed between the anode layer and the cathode layer.

In the present disclosure, the solid-state battery means a battery containing a solid electrolyte. The solid-state battery may be a solid-state battery containing a solid electrolyte and a liquid material, or it may be an all-solid-state battery which is a solid-state battery not containing a liquid material.

When a set of the cathode, the solid electrolyte layer and the anode is regarded as a power generation unit, the solid-state battery may have only one power generation unit, or it may have two or more power generation units. When the solid-state battery has two or more power generation units, the power generation units may be connected in series or parallel.

### [Cathode]

The cathode includes a cathode layer. As needed, the cathode includes a cathode collector.

### [Cathode Layer]

The cathode layer contains a cathode active material. As needed, the cathode layer may contain a solid electrolyte, an electroconductive material, a binder, etc.

As the cathode active material, examples include, but are not limited to, lithium nickel cobalt aluminum oxide (NCA), LiCoO₂, LiNiₓCo₁₋ₓO₂ (0<x<1), LiNi_{1/3}Co_{1/3}Mn_{1/3}O₂, LiMnO₂, LiMn₂O₄, LiNiO₂, LiVO₂, a different element-substituted Li—Mn spinel, lithium titanate, lithium metal phosphate, LiCoN, Li₂SiO₃ and Li₄SiO₄. As the different element-substituted Li—Mn spinel, examples include, but are not limited to, LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄ and LiMn_{1.5}Zn_{0.5}O₄. As the lithium titanate, examples include, but are not limited to, Li₄Ti₅O₁₂. As the lithium metal phosphate, examples include, but are not limited to, LiFePO₄, LiMnPO₄, LiCoPO₄ and LiNiPO₄. The cathode active material may be an active material containing a Ni element and a Co element.

The form of the cathode active material is not particularly limited. The cathode active material may be in a particulate form (cathode active material particles). The average particle diameter of the cathode active material particles is not particularly limited, and it may be from 1 nm to 100 μm.

On the surface of the cathode active material, a coating layer containing a Li ion conductive oxide may be formed. This is because a reaction between the cathode active material and the solid electrolyte can be suppressed.

As the Li ion conductive oxide, examples include, but are not limited to, LiNbO₃, Li₄Ti₅O₁₂, and Li₃PO₄. The thickness of the coating layer is, for example, 0.1 nm or more, and it may be 1 nm or more. On the other hand, the thickness of the coating layer is, for example, 100 nm or less, and it may be 20 nm or less. The coating rate of the coating layer on the surface of the cathode active material is, for example, 70% or more, and it may be 90% or more.

As the electroconductive material, a known material can be used, such as a carbon material and metal particles. As the carbon material, examples include, but are not limited to, at least one selected from the group consisting of acetylene black (AB), furnace black, VGCF, carbon nanotube and carbon nanofiber. Among them, at least one selected from the group consisting of VGCF, carbon nanotube and carbon nanofiber may be used, from the viewpoint of electron conductivity. As the metal particles, examples include, but are not limited to, particles of Ni, Cu, Fe and SUS.

The amount of the electroconductive material contained in the cathode layer is not particularly limited.

As the solid electrolyte, examples include, but are not limited to, a solid electrolyte that can be contained in the above-described solid electrolyte layer.

The amount of the solid electrolyte contained in the cathode layer is not particularly limited. When the total mass of the cathode layer is 100 mass %, the amount of the solid electrolyte may be in a range of from 1 mass % to 80 mass %, for example.

As the binder, examples include, but are not limited to, a binder that can be contained in the above-described solid electrolyte layer. The amount of the binder contained in the cathode layer is not particularly limited.

The thickness of the cathode layer is not particularly limited.

The cathode layer can be formed by a conventionally known method.

For example, the cathode active material and, as needed, other components are put in a solvent; they are stirred to prepare a cathode paste; and the cathode paste is applied on one surface of a support such as a cathode collector; and the applied slurry is dried, thereby obtaining the cathode layer.

As the solvent, examples include, but are not limited to, a solvent that can be used in the production of the above-described solid electrolyte paste.

The method for applying the cathode paste on one surface of the support such as the cathode collector, is not particularly limited. As the method, examples include, but are not limited to, the doctor blades method, the metal mask printing method, the static coating method, the dip coating method, the spread coating method, the roll coating method, the gravure coating method, and the screen printing method.

As the support, one having self-supporting property can be appropriately selected and used without particular limitation. For example, a metal foil such as Cu and Al can be used.

### [Cathode Collector]

As the cathode collector, a known metal that can be used as the collector of solid-state battery, can be used. As the metal, examples include, but are not limited to, a metal material containing one or more elements selected from the group consisting of Cu, Ni, Al, V, Au, Pt, Mg, Fe, Ti, Co, Cr, Zn, Ge and In. As the cathode collector, examples include, but are not limited to, SUS, aluminum, nickel, iron, titanium and carbon. The form of the cathode collector is not particularly limited. As the form, examples include, but are not limited to, various kinds of forms such as a foil form and a mesh form.

### [Anode]

The anode includes an anode layer. As needed, the anode includes an anode collector.

### [Anode Layer]

The anode layer contains an anode active material. As needed, the anode layer may contain at least one of a solid electrolyte, an electroconductive material or a binder.

As the anode active material, examples include, but are not limited to, a Li-based active material, a carbon-based active material, an oxide-based active material and a Si-based active material. Of them, the anode active material may be a Si-based active material. A Si-based active material has a high discharge capacity; however, it has a large expansion coefficient and when it is used, there is a possibility that stress is applied to a solid electrolyte layer and cause damage thereto. In the present disclosure, the solid electrolyte layer has high tensile strength. Accordingly, even in the case of using a Si-based active material, a solid-state battery which can suppress damage to the solid electrolyte layer and which has a high discharge capacity, is obtained.

As the Li-based active material, examples include, but are not limited to, a lithium metal and a lithium alloy.

As the carbon-based active material, examples include, but are not limited to, graphite, hard carbon and soft carbon.

As the oxide-based active material, examples include, but are not limited to, lithium titanate.

As the Si-based active material, examples include, but are not limited to, elemental Si, a Si alloy and silicon oxide. As the form of the anode active material, examples include, but are not limited to, a particulate form. The average particle diameter of the anode active material particles is not particularly limited, and it may be from 1 nm to 100 μm.

As the electroconductive material, solid electrolyte and binder used in the anode layer, examples include, but are not limited to, those exemplified above as the electroconductive material, solid electrolyte and binder which can be contained in the cathode layer. The thickness of the anode layer is not particularly limited. It may be from 0.1 μm to 1000 μm.

### [Anode Collector]

The material for the anode collector may be a material that is not alloyed with Li, such as SUS, copper and nickel. As the form of the anode collector, examples include, but are not limited to, a foil form and a plate form. The plan-view shape of the anode collector is not particularly limited, and examples thereof include, but are not limited to, a circular shape, an ellipse shape, a rectangular shape and any arbitrary polygonal shape. The thickness of the anode collector varies depending on the shape. For example, it may be in a range of from 1 μm to 50 μm, or it may be in a range of from 5 μm to 20 μm.

### [Solid Electrolyte Layer]

The solid-state battery of the present disclosure includes the solid electrolyte layer of the present disclosure.

The nonwoven fabric included in the solid electrolyte layer may be or may not be in direct contact with at least one of the cathode layer or the anode layer. Another solid electrolyte layer may be disposed between the nonwoven fabric included in the solid electrolyte layer and at least one of the cathode layer or the anode layer. By disposing another solid electrolyte layer, the internal resistance of the solid-state battery is decreased. Another solid electrolyte layer contains a solid electrolyte, and it may contain a binder, as needed. As the solid electrolyte and the binder, examples include, but are not limited to, those exemplified above as the solid electrolyte and binder which can be contained in the solid electrolyte layer of the present disclosure. Another solid electrolyte layer does not include a nonwoven fabric. The thickness of another solid electrolyte layer is not particularly limited.

As needed, the solid-state battery includes an outer casing for housing the cathode layer, the anode layer, the anode collector, the solid electrolyte layer, etc.

The material for the outer casing is not particularly limited, as long as it is a material stable in solid electrolyte. As the material, examples include, but are not limited to, aluminum and a resin such as polypropylene, polyethylene and acrylic resin.

As the form of the solid-state battery, examples include, but are not limited to, a coin form, a laminate form, a cylindrical form and a square form.

The solid-state battery may be a primary battery, or it may be a secondary battery. As the applications of the solid-state battery, examples include, but are not limited to, the power source of vehicles such as a hybrid electric vehicle (HEV), a plug-in hybrid electric vehicle (PHEV), a battery electric vehicle (BEV), a gasoline vehicle and a diesel vehicle. Of them, the solid-state battery of the present disclosure may be used in the driving power supply of a hybrid electric vehicle (HEV), a plug-in hybrid electric vehicle (PHEV) or a battery electric vehicle (BEV). Also, the solid-state battery may be used as the powder source of mobile objects other than vehicles, such as railroads, ships and aircrafts, or it may be used as the power source of electrical appliances such as an information processing device.

### 3. Solid-State Battery Production Method

The method for producing the solid-state battery according to the present disclosure comprises obtaining a stack by disposing the solid electrolyte layer of the present disclosure between an anode layer and a cathode layer and pressing the stack.

In the step of obtaining the stack, the solid electrolyte layer of the present disclosure may be disposed on the first electrode of one of the cathode layer and the anode layer, and they may be preliminarily pressed. Then, the release film may be stripped from the nonwoven fabric, and the second electrode of the other one of the cathode layer and the anode layer may be disposed on the solid electrolyte layer to obtain the stack. The press pressure of the pressing step is not particularly limited, and it may be larger than the press pressure of the preliminary pressing.

The pressing method is not particularly limited. As the pressing method, examples include, but are not limited to, roll pressing.

Depending on the pressing of the pressing step, the nonwoven fabric and solid electrolyte included in the solid electrolyte layer are less likely to deform. Accordingly, the nonwoven fabric and solid electrolyte included in the pressed solid electrolyte layer can be equated with the nonwoven fabric and solid electrolyte included in the solid electrolyte layer before subjected to the pressing.

### EXAMPLES

### Example 1

### [Preparation of Nonwoven Fabric]

As shown in Table 1, a nonwoven fabric made of PET and having an average fiber diameter of 5 μm and a porosity of 73% was prepared. The basis weight of the nonwoven fabric was 1 g/cm². The thickness of the nonwoven fabric was 30 μm.

### [Production of Solid Electrolyte Layer]

As shown in Table 1, 15LiBr·10LiI·75(0.75Li₂S·0.25P₂S₅) glass ceramic particles having an average particle diameter (D50) of 0.2 μm were used as a sulfide solid electrolyte.

With respect to 100 mass % of the sulfide solid electrolyte, 3 mass % of a SBR (styrene-butadiene rubber)-based binder was weighed out, and they were mixed with butyl butyrate to obtain a solid content of 50 mass %. The mixture was subjected to ultrasonic dispersion for one minute by use of an ultrasonic disperser, thereby obtaining a solid electrolyte paste).

Next, the nonwoven fabric was placed on a release film (a Si-coated PET film) having a thickness of 25 μm. By blade coating with a commercially-available applicator, the solid electrolyte paste was evenly applied thereto so that the coating weight was 3.0 mg/cm².

Then, a coating film thus obtained was dried at 100° C. for 60 minutes, thereby obtaining a solid electrolyte layer including the nonwoven fabric on the release film.

### [Production of Cathode]

As a cathode active material, LiNi_{1/3}Mn_{1/3}CO_{1/3}O₂ particles having an average particle diameter (D50) of 10 μm and a specific surface area of 1 m²/g were used.

The surface of the cathode active material was coated with LiNbO₃ by the sol-gel method.

As the solid electrolyte, the same sulfide solid electrolyte as the solid electrolyte layer was used.

With respect to 100 mass % of the cathode active material, 50 mass % of the sulfide solid electrolyte, 10 mass % of an electroconductive material (CNF, specific surface area 14 m²/g) and 1 mass % of a SBR (styrene-butadiene rubber)-based binder were weighed out, and they were mixed with butyl butyrate to obtain a solid content of 60 mass %. The mixture was subjected to ultrasonic dispersion for one minute by use of an ultrasonic disperser, thereby obtaining a cathode paste.

Next, by blade coating with a commercially-available applicator, the cathode paste was evenly applied onto a cathode collector made of an aluminum foil having a thickness of 15 μm so that the coating weight was 25 mg/cm².

Next, a coating film thus obtained was dried at 100° C. for 60 minutes, thereby obtaining a cathode in which a cathode layer was formed on the cathode collector made of the aluminum foil.

### [Production of Anode]

As an anode active material, Si particles having an average particle diameter (D50) of 3 μm and a specific surface area of 4 m²/g were used. As a sulfide solid electrolyte, the same sulfide solid electrolyte as the solid electrolyte layer was used.

With respect to 100 mass % of the anode active material, 100 mass % of the sulfide solid electrolyte, 10 mass % of an electroconductive material (CNF, specific surface area 14 m²/g) and 2 mass % of a SBR (styrene-butadiene rubber)-based binder were weighed out, and they were mixed with butyl butyrate to obtain a solid content of 40 mass %. The mixture was subjected to ultrasonic dispersion for one minute by use of an ultrasonic disperser, thereby obtaining an anode paste).

Next, by blade coating with a commercially-available applicator, the anode paste was evenly applied onto an anode collector made of a surface-roughened copper foil having a thickness of 20 μm so that the coating weight was 5 mg/cm².

Next, a coating film thus obtained was dried at 100° C. for 60 minutes, thereby obtaining an anode in which an anode layer was formed on the anode collector made of the surface-roughened copper foil.

### [Production of Solid-State Battery]

The anode was cut in the form of a 1.2 cm×1.2 cm square. The solid electrolyte layer with the release film was cut in the same form and stacked on the anode layer so that the anode layer was in contact with the solid electrolyte layer. Then, they were roll-pressed at a press pressure of 1 ton/cm².

Next, the release film was stripped from the solid electrolyte layer stacked on the anode. The cathode was cut in the form of a 1.0 cm×1.0 cm square and stacked on the solid electrolyte layer stacked on the anode so that the cathode layer was in contact with the solid electrolyte layer. Then, they were roll-pressed at a press pressure of 4 ton/cm².

The thus-obtained stack was enclosed in an outer casing, thereby producing the test solid-state battery of Example 1. The outer casing was made of an aluminum laminate film and equipped with cathode and anode terminals, and the test solid-state battery was an all-solid-state lithium ion secondary battery.

### Example 2

A solid-state battery was produced in the same manner as Example 1, except that a nonwoven fabric made of PET and having an average fiber diameter of 3 μm and a porosity of 77% was used, and 15LiBr·10LiI·75(0.75Li₂S·0.25P₂S₅) glass ceramic particles having an average particle diameter (D50) of 0.1 μm were used as a sulfide solid electrolyte.

### Example 3

A solid-state battery was produced in the same manner as Example 1, except that 15LiBr·10LiI·75(0.75Li₂S·0.25P₂S₅) glass ceramic particles having an average particle diameter (D50) of 0.1 μm were used as a sulfide solid electrolyte.

### Example 4

A solid-state battery was produced in the same manner as Example 1, except that a nonwoven fabric made of PET and having an average fiber diameter of 10 μm and a porosity of 75% was used.

### Example 5

A solid-state battery was produced in the same manner as Example 1, except that a nonwoven fabric made of PET and having an average fiber diameter of 10 μm and a porosity of 75% was used, and 15LiBr·10LiI·75(0.75Li₂S·0.25P₂S₅) glass ceramic particles having an average particle diameter (D50) of 0.1 μm were used as a sulfide solid electrolyte.

### Comparative Example 1

A solid-state battery was produced in the same manner as Example 1, except that a nonwoven fabric was not used, and 15LiBr·10LiI·75(0.75Li₂S·0.25P₂S₅) glass ceramic particles having an average particle diameter (D50) of 0.5 μm were used as a sulfide solid electrolyte.

### Comparative Example 2

A solid-state battery was produced in the same manner as Example 1, except that a nonwoven fabric made of PET and having an average fiber diameter of 3 μm and a porosity of 77% was used, and 15LiBr·10LiI·75(0.75Li₂S·0.25P₂S₅) glass ceramic particles having an average particle diameter (D50) of 0.5 μm were used as a sulfide solid electrolyte.

### Comparative Example 3

A solid-state battery was produced in the same manner as Example 1, except that a nonwoven fabric made of PET and having an average fiber diameter of 5 μm and a porosity of 21% was used, and 15LiBr·10LiI·75(0.75Li₂S·0.25P₂S₅) glass ceramic particles having an average particle diameter (D50) of 0.5 μm were used as a sulfide solid electrolyte.

### Comparative Example 4

A solid-state battery was produced in the same manner as Example 1, except that a nonwoven fabric made of PET and having an average fiber diameter of 5 μm and a porosity of 48% was used, and 15LiBr·10LiI·75(0.75Li₂S·0.25P₂S₅) glass ceramic particles having an average particle diameter (D50) of 0.5 μm were used as a sulfide solid electrolyte.

### Comparative Example 5

A solid-state battery was produced in the same manner as Example 1, except that a nonwoven fabric made of PET and having an average fiber diameter of 5 μm and a porosity of 75% was used, and 15LiBr·10LiI·75(0.75Li₂S·0.25P₂S₅) glass ceramic particles having an average particle diameter (D50) of 0.5 μm were used as a sulfide solid electrolyte.

### Comparative Example 6

A solid-state battery was produced in the same manner as Example 1, except that a nonwoven fabric made of PET and having an average fiber diameter of 5 μm and a porosity of 91% was used, and 15LiBr·10LiI·75(0.75Li₂S·0.25P₂S₅) glass ceramic particles having an average particle diameter (D50) of 0.5 μm were used as a sulfide solid electrolyte.

### Comparative Example 7

A solid-state battery was produced in the same manner as Example 1, except that a nonwoven fabric made of PET and having an average fiber diameter of 3 μm and a porosity of 77% was used.

### Comparative Example 8

A solid-state battery was produced in the same manner as Example 1, except that a nonwoven fabric made of PET and having an average fiber diameter of 10 μm and a porosity of 77% was used, and 15LiBr·10LiI·75(0.75Li₂S·0.25P₂S₅) glass ceramic particles having an average particle diameter (D50) of 0.5 μm were used as a sulfide solid electrolyte.

### [Battery Resistance Measurement]

Each of the solid-state batteries of Examples 1 to 5 and Comparative Examples 1 to 8 was charged with constant current and constant voltage at a current value of 2 mA, an upper limit voltage of 4.5 V and a lower limit voltage of 2.5 V. Then, the battery was discharged with constant current and constant voltage.

Next, the battery was charged with constant current and constant voltage at a current value of 2 mA and an upper limit of 3.6 V. After a pause of 10 minutes, the battery was discharged with constant current at a current value of 10 mA and a lower limit voltage of 0.0 V for 10 seconds. Then, the battery resistance R(=ΔV/I) was calculated according to the law of Ohm. The results of the battery resistances of Examples 1 to 5 and Comparative Examples 1 to 8 are shown in Table 1.

### <Tensile Strength Measurement>

By reference to JIS L 1096, the tensile strength of the solid electrolyte layers produced in Examples 1 to 5 and Comparative Examples 2 to 8 were measured by the following method.

A stack was obtained by stacking another release film on the solid electrolyte paste-coated surface of the solid electrolyte layer on the release film, which was produced in [Production of solid electrolyte layer]. The stack was roll-pressed at a press pressure of 1 ton/cm. Then, the release films were stripped from both surfaces of the solid electrolyte layer, thereby producing a self-supporting solid electrolyte layer. The self-supporting solid electrolyte layer was cut into a strip having a width of 1 cm and a length of 5 cm. The tensile strength of the solid electrolyte layer was measured by the predetermined tensile test. The results are shown in Table 1.

TABLE 1

| | Average fiber diameter of | | | | Battery | |
|---|---|---|---|---|---|---|
| | nonwoven fabric/Average | Average particle | Average fiber | Porosity of | resistance | |
| | particle diameter of solid | diameter of solid | diameter of | nonwoven | Compared to | Tensile |
| | electrolyte particles | electrolyte particles | nonwoven fabric | fabric | Comparative | strength |
| | m/m | μm | μm | % | Example 1 | N/15 mm |
| Comparative | — | 0.5 | — | — | 1.00 | — |
| Example 1 | | | | | | |
| Comparative | 6 | 0.5 | 3 | 77% | 2.82 | 2.0 |
| Example 2 | | | | | | |
| Comparative | 10 | 0.5 | 5 | 21% | 4.95 | 2.9 |
| Example 3 | | | | | | |
| Comparative | 10 | 0.5 | 5 | 48% | 3.52 | 2.0 |
| Example 4 | | | | | | |
| Comparative | 10 | 0.5 | 5 | 75% | 2.74 | 1.6 |
| Example 5 | | | | | | |
| Comparative | 10 | 0.5 | 5 | 91% | 2.29 | 1.1 |
| Example 6 | | | | | | |
| Comparative | 15 | 0.2 | 3 | 77% | 2.14 | 1.8 |
| Example 7 | | | | | | |
| Comparative | 20 | 0.5 | 10 | 77% | 1.72 | 1.7 |
| Example 8 | | | | | | |
| Example 1 | 25 | 0.2 | 5 | 73% | 1.43 | 1.6 |
| Example 2 | 30 | 0.1 | 3 | 77% | 1.44 | 1.8 |
| Example 3 | 50 | 0.1 | 5 | 73% | 1.44 | 1.5 |
| Example 4 | 50 | 0.2 | 10 | 75% | 1.49 | 1.5 |
| Example 5 | 100 | 0.1 | 10 | 75% | 1.37 | 1.6 |

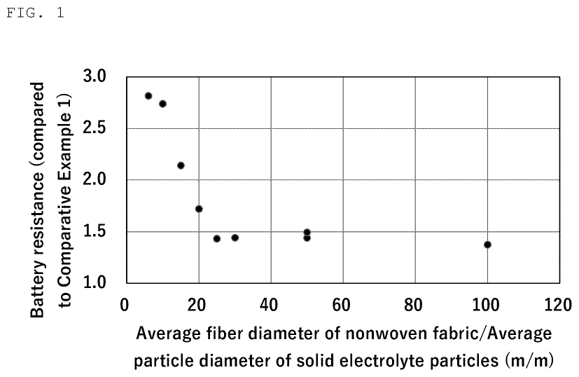

FIG. 1 is a graph showing a relationship between the resistance of each solid-state battery and the ratio of the average fiber diameter of the nonwoven fabric of each of the solid electrolyte layers produced in Examples 1 to 5 and Comparative Examples 2, 5, 7 and 8 to the average particle diameter of the solid electrolyte particles thereof (the average fiber diameter of the nonwoven fabric/the average particle diameter of the solid electrolyte particles).

As shown by Comparative Examples 3 to 6 in Table 1, when having the same average solid electrolyte particle diameter and the same average nonwoven fabric fiber diameter, the battery resistance decreases as the porosity of the nonwoven fabric increases; however, the tensile strength of the solid electrolyte layer decreases.

As shown in FIG. 1 and Table 1, the battery resistance rapidly increases when the ratio of the average fiber diameter of the nonwoven fabric to the average particle diameter of the solid electrolyte particles (the average fiber diameter of the nonwoven fabric/the average particle diameter of the solid electrolyte particles) is less than 25. Meanwhile, the battery resistance rapidly decreases when the ratio is 25 or more. In Examples 1 to 5, the porosity was adjusted so as to be kept high, and the ratio of the average fiber diameter of the nonwoven fabric to the average particle diameter of the solid electrolyte particles (the average fiber diameter of the nonwoven fabric/the average particle diameter of the solid electrolyte particles) was adjusted so as to be 25 or less. Accordingly, the battery resistance can be decreased to the desired value, while achieving the desired tensile strength. This is thought to be because, since the average particle diameter of the solid electrolyte particles is sufficiently smaller than the average fiber diameter of the nonwoven fabric, the solid electrolyte particles are likely to be linked in the solid electrolyte layer.

1. A solid electrolyte layer for solid-state batteries,
wherein the solid electrolyte layer comprises a nonwoven fabric and a solid electrolyte;
wherein the solid electrolyte is disposed in an interior of the nonwoven fabric;
wherein the solid electrolyte is solid electrolyte particles; and
wherein a ratio of an average fiber diameter of the nonwoven fabric to an average particle diameter of the solid electrolyte particles, is 25 or more and 100 or less.

2. The solid electrolyte layer according to claim 1, wherein the ratio of the average fiber diameter of the nonwoven fabric to the average particle diameter of the solid electrolyte particles, is 25 or more and 50 or less.

3. The solid electrolyte layer according to claim 1, wherein a porosity of the nonwoven fabric is 73% or more and less than 91%.

4. The solid electrolyte layer according to claim 1, wherein an average fiber diameter of the nonwoven fabric is 3 μm or more and 10 μm or less.

5. The solid electrolyte layer according to claim 1, wherein an average particle diameter of the solid electrolyte particles is 0.1 μm or more and less than 0.5 μm.

6. The solid electrolyte layer according to claim 1, wherein the nonwoven fabric is composed of polyethylene terephthalate.

7. The solid electrolyte layer according to claim 1, wherein the solid electrolyte contains a sulfide solid electrolyte.

8. A solid-state battery comprising an anode layer, a cathode layer, and the solid electrolyte layer defined by claim 1 and disposed between the anode layer and the cathode layer.

9. The solid-state battery according to claim 8, wherein the anode layer contains a Si-based active material as an anode active material.

10. The solid-state battery according to claim 8,
wherein the cathode layer contains a cathode active material, and
wherein the cathode active material contains a Ni element and a Co element.

11. A method for producing a solid-state battery, comprising:
obtaining a stack by disposing the solid electrolyte layer defined by claim 1 between an anode layer and a cathode layer, and
pressing the stack.
